(19) United States
(12) Patent Application Publication
(10) Pub. No.: US 2024/0020971 A1
(43) Pub. Date: Jan. 18, 2024

(54) SYSTEM AND METHOD FOR IDENTIFYING WEEDS

(71) Applicant: UPL LTD, Mumbai (IN)

(72) Inventors: Shantanu CHATTERJEE, Mumbai (IN); Prajakta AHER, Mumbai (IN); Vedansh KEDIA, Mumbai (US); Mohammad Shahbaz HUSSAIN, Mumbai (IN)

(21) Appl. No.: 18/552,943

(22) PCT Filed: Mar. 31, 2022
(86) PCT No.: PCT/IB2022/053007

§ 371 Date: Sep. 28, 2023

(30) Foreign Application Priority Data
Mar. 31, 2021 (IN) 202121014782

(51) Int. Cl. G06V 20/10; G06N 3/0464

(52) U.S. Cl. CPC G06V 20/188; G06N 3/0464

(57) ABSTRACT

The present invention relates to a system and method for identifying weeds in an image. The present invention involves a server (102) connected to mobile devices (104, 108) of registered users (106) and sellers (110). The server (102) receives and validates images associated with an AOI having weeds, captured by the user (106), and rejects unvalidated images to enter into database of the server (102). The server (102) further receives the location of the AOI having weeds and the location of the sellers (110) and the buyers (106), using the corresponding mobile devices (104, 108). The server (102) extracts attributes of weeds from the validated images, and processes and computes the attributes and images to identify weeds. The server (102) provides the users (106) with details of recommended products for the weeds, and details of sellers (110) of the product based on the geo-location of the AOI and the weed.

### TECHNICAL FIELD

The present disclosure relates to weed recognition systems and equipment. More particularly, the present disclosure relates to a system and method for identifying weeds in images associated with an area having target crops.

### BACKGROUND

Background description includes information that may be useful in understanding the present invention. It is not an admission that any of the information provided herein is prior art or relevant to the presently claimed invention, or that any publication specifically or implicitly referenced is prior art.

Weeds are unwanted plants that grow in farmland or agricultural fields near desired crops or plants being cultivated intentionally. Weeds survive and grow undesirably on nutrients and water that are meant for the corps or plants being cultivated intentionally, thereby increasing the overall nutrients and water required by the farmland or crops. These weeds may survive for the long-term as they are capable of adapting to local conditions, farming effects, climate, soil, and other environmental factors and conditions. There are numerous and diverse types of weeds found or present farmland, which compete with the target crops for water and nutrients, occupy the upper surface and underground area of the farmland, affect photosynthesis, and interfere with the growth of target crops.

Various products such as herbicides are available in the market that can be used against these weeds to selectively remove, kill or inhibit their growth. However, these herbicides are weed specific and any unadministered use of these products over farmland can also affect the desired target crops as well. Besides, it is also difficult for an ordinary person to identify the weeds present along with the target crops and determine the specific products to be used against these weeds without hampering the desired crops.

Various technologies are present in the art which allows skilled as well as ordinary people to identify some of these weeds present in the farmland. One such technology available in the market is Savvy Weed ID which collects information from users regarding the structure of weed and filters the weed list based on it. However, Savvy Weed ID fails to overcome the above deficiency of allowing the ordinary person to use the technology, as it would be difficult for the ordinary person to identify and collect the required information about the structure of the weed. In addition, Savvy Weed ID is limited to providing a list of recommended products without considering the geo-location of the weeds, which would make it difficult for the users to use it worldwide or across a larger geographical area. Also, as the type of products required as well as their usage varies with geographical conditions as well as the availability of manufactured products in the geo-location of the weeds, thus, the limited list of recommended products Savvy Weed ID without considering the geo-location of the weeds and list of products being manufactured in the geo-location of the weeds, makes Savvy Weed ID inefficient, unreliable, and limited for use in smaller regions.

CN110232344A discloses a program for the identification of weed by using a computer and an identification device. The device includes a camera, an image acquisition card, and processors to capture images of weeds. Said program matches the captured images of the weed with pre-stored images of weeds being stored in a database to identify the corresponding weed. However, this direct matching of images of weeds is an old brute force approach, which is inaccurate, inefficient, and highly unreliable, and requires replacement with improved and reliable technology.

CN111523457A provides a weed recognition method and weed treatment equipment. The method involves the use of a dedicated image collection device that can be used in a controlled environment coping with the sources of noise like the flickering of light, fringing, shadow, tint, and the likes, by using all sorts of hues from the visible spectrum. As a result, the method is limited to be used in a controlled environment using the dedicated device only and becomes highly unreliable and inefficient when used in real outside conditions.

In addition, all the above-cited prior arts fail to authenticate users as well as sellers of the product, which makes them unsafe and unreliable to be used. Also, the above-cited prior arts fail to provide details about recommended products that can be used against the identified weeds, and corresponding details of sellers based on the current geo-location of the weeds. Besides, all the above-cited prior arts fail to identify weeds at their different growth stages or cycles (germination stage to fruiting stage), which is required for the recommendation of an appropriate product for the weed based on the growth stage and geo-location of the weed.

There is, therefore, a need to overcome the drawbacks, shortcomings, and limitations associated with the existing weed recognition approach and provide an easy to use, efficient, accurate, and reliable system and method for identifying weeds in images being captured using mobile devices in all environmental conditions and at different growth stages of the weeds, which provides authenticated users with details about products that can be used against the identified weeds, and corresponding details of available authenticated sellers based on current geo-location of the weeds.

### OBJECTS OF THE PRESENT DISCLOSURE

Some of the objects of the present disclosure, which at least one embodiment herein satisfies are as listed herein below.

It is an object of the present disclosure to overcome the drawbacks, shortcomings, and limitations associated with existing weed recognition systems and methods.

It is an object of the present disclosure to identify weeds in images being captured using mobile devices, irrespective of environmental conditions.

It is an object of the present disclosure to identify weeds at different growth stages of the weed.

It is an object of the present disclosure to provide a stage-wise weed identification for detecting weeds at their different growth stages and also recommend the associated product for the weed based on the growth stage, type, and geo-location of the weed.

It is an object of the present disclosure to improve the accuracy level of the weed identification process by not just classifying the image to a particular weed name but also locating the position of the weed in the image.

It is an object of the present disclosure to provide a system and method for identifying weeds using mobile devices, which provides users with various reference images of the identified weeds in order of possibility to validate the recommendations and provide alternate solutions on customer satisfaction.

It is an object of the present disclosure to provide a product catalog feature to users, which can be added to help users browse through all the products and their details.

It is an object of the present disclosure to provide a system and method for identifying weeds using mobile devices, which alerts users to recapture the images of the weed of identification in case the users fail to correctly capture the image of the weeds.

It is an object of the present disclosure to provide a system and method for identifying weeds, which restricts the entry of invalid or unwanted images or data into the system, which are not related to weeds, in order to prevent any security threats.

It is an object of the present disclosure to provide a system and method for identifying weeds using mobile devices, which provides authenticated users with details about products that can be used against the identified weeds at different growth stages, and corresponding details of available authenticated sellers based on current geo-location of the weeds.

It is an object of the present disclosure to train the weed identification system with previous as well as present datasets to improve the weed identification capability of the system for upcoming weed identification requests and processes.

It is an object of the present disclosure to improve the computation speed and reduce the computational load on the system while identifying weeds in the captured images.

It is an object of the present disclosure to provide a system and method for identifying weeds in images being captured using mobile devices, which provides authenticated users with details about products that can be used against the identified weeds, as well as corresponding details of available authenticated sellers based on current geo-location of the weeds.

### SUMMARY

The present disclosure relates to an easy to use, efficient, accurate, and reliable system and method for identifying weeds in images being captured using mobile devices in all environmental conditions and at different growth stages of the weeds, which provides authenticated users with details about products that can be used against the identified weeds, and corresponding details of available authenticated sellers based on current geo-location of the weeds.

The present invention (system and method) may involve mobile devices (first mobile device) associated with registered users. These mobile devices may comprise a camera to capture images of an area of interest (AOI) having the weed, a positioning unit such as a GPS module, and the likes to monitor the location of the user and the AOI. The mobile devices of all the users may be in communication with a computing unit or server. The user may capture the images of the weed or the images of a larger view (AOI) having the weed in it, using their mobile devices. These images along with the geo-location of the AOI/weed (or where the image was captured) may then be transmitted to the computing unit for further processing and weed identification.

The computing unit may be configured with a convolutional neural network, which may be operable to identify one or more weeds in the captured images, at different growth stages of the corresponding weed. For instance, the CNN may enable the computing unit to identify weeds at their germination stage, growth stage, fruiting stage, and the likes. The computing unit may further extract and provide details associated with the identified weed, which may include but are not limited to a common name, family name, class, and regional name of the identified weed. Further, the computing unit may recommend products for the identified weed or provide a product catalog feature that may help users to browse through all the products and get details about the products. The product catalog may include but is not limited to type, name, price, usage instructions, dosage, application, and precautionary measures of the recommended product. Furthermore, the product catalog may also include details of registered sellers of the recommended products, which may be suggested based on the current geo-location of the users/weed. The seller details may include but are not limited to name, location, contact number, product reviews, and seller reviews.

The computing unit may store the images captured by the registered users after the identification of the weeds, which may help train the computing unit or system for upcoming weed identification requests and processes, making the system accurate and efficient. In addition, the computing unit may also allow the registered users to later access and select, using their mobile devices, the previously stored images for identification of the weeds in the selected images and getting the details of the weed, recommended products, and associated sellers of the product.

Further, the computing unit may also determine the position of the identified weeds in the captured images, and may correspondingly generate a sliding object detection window for each of the identified weeds. The sliding window may be computed based on the dimension and position of the identified weeds in the image frame. Further, the computing unit may superimpose the generated sliding windows on the captured images, which improves the accuracy levels of weed identification by not just classifying the image to a particular weed name but also locating the position of the weed in that input image.

Furthermore, along with the inference, the reference images of the identified weed name may also be provided to the user to validate the weed detection. For instance, in case the user is unsure about weed detection, the user can choose to view more possibilities. The system may list the alternatives in order of possibility. Further, if a user finds a better weed image matching the actual captured image by him/her, the image may be selected to get the recommendation accordingly. This allows the validation of recommendations using similar images and provides alternative solutions based on user satisfaction.

The present invention may allow only the registered users and registered sellers to access the system, thereby avoiding any data breach of the users and improper use of the system by any hacker or miscreant. The computing unit may initially request user or seller credentials to authenticate the users, sellers, and their respective mobile devices when the users or sellers register with the system for the first time. The computing unit may also authenticate the users/sellers every time the users or sellers connect or log into the system so that only authenticated users and sellers can access the system.

Thus, the present invention provides an easy-to-use, efficient, accurate, and reliable system and method for identifying weeds in images being captured using mobile devices in all environmental conditions and at different growth stages of the weeds. Besides, the present invention also provides authenticated users with details about products that can be used against the identified weeds, and the corresponding details of available authenticated sellers based on the current geo-location of the weeds.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary network architecture of the system and method for identifying weeds, in accordance with an embodiment of the present invention.

FIG. 2 illustrates an exemplary architecture of a mobile device of the system and method, in accordance with an embodiment of the present disclosure.

FIG. 3 illustrates an exemplary architecture of a computing unit (or server) of the system and method, in accordance with an embodiment of the present disclosure.

FIG. 4 illustrates an exemplary flow diagram for identifying weeds using the system and method, in accordance with an embodiment of the present disclosure.

FIG. 5 illustrates an exemplary view of a display of the mobile device, in accordance with an embodiment of the present disclosure.

FIG. 6 illustrates an exemplary architecture of the system, in accordance with an embodiment of the present disclosure.

FIGS. 7A to 7F illustrate exemplary views of a display or interface of the mobile device associated with the user, showing the identified weed, and corresponding products and sellers, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

According to an aspect, the present disclosure relates to an easy to use, efficient, accurate, and reliable system and method for identifying weeds in images being captured using mobile devices in all environmental conditions and at different growth stages of the weeds, which provides authenticated users with details about products that can be used against the identified weeds, and corresponding details of available authenticated sellers based on current geo-location of the weeds.

According to an aspect, the present disclosure elaborates upon a method for identification of weeds in images, the method comprising the steps of receiving one or more images of an area of interest (AOI) being captured by one or more mobile devices associated with one or more registered users, and a corresponding location of the AOI; identifying one or more weeds in the received one or more images, training a computing unit, with the identified one or more weeds; extracting one or more details pertaining to the identified one or more weeds based on the determined location of the AOI and the associated weeds, and transmitting a first set of data packets to the one or more first mobile devices.

In an embodiment, the method comprises the steps of: detecting and extracting one or more attributes associated with one or more weeds from the received one or more images of the AOI, wherein the step of extracting the one or more attributes is performed upon a positive detection of the one or more attributes in the received one or more images; performing dimensionality reduction on the extracted one or more attributes to select a first set of attributes amongst the extracted one or more attributes; generating and feeding, to an activation function, a feature vector corresponding to the selected first set of attributes, to determine probability of the received one or more images to fall in one or more class associated with one or more known weeds; and identifying one or more weeds in the one or more images based on the determined probability of the one or more class, wherein the identified one or more weeds is associated with corresponding class amongst the one or more class that has a maximum determined probability.

In an embodiment, the step of performing dimensionality reduction on the extracted one or more attributes involves reducing the dimensionality of the extracted one or more attributes of the captured images to a dimensionality ranging from 200×200×3 to 900×900×3.

In an embodiment, the step of performing dimensionality reduction on the extracted one or more attributes further involves reducing the dimensionality of the extracted one or more attributes of the captured images to a dimensionality ranging from 1×1×1700 to 10×10×250.

In an embodiment, upon a negative detection of the one or more attributes in the received one or more images, the method comprises the step of transmitting, to the one or more first mobile devices, a second set of data packets pertaining to an alert message for initiating recapturing of one or more images of the AOI.

In an embodiment, the method comprises the step of enabling the one or more registered users to access and select, using the one or more first mobile devices, at least one of the images for identification of the one or more weeds from the selected images and corresponding one or more details.

In an embodiment, the one or more details pertaining to the identified one or more weeds comprises: a first set of details associated with the identified one or more weeds, and selected from a group consisting of common name, family name, class, and regional name; and a second set of details associated with one or more recommended products for the identified one or more weeds, and selected from a group consisting of type, name, price, usage instructions, dosage, application, and precautionary measures; and a third set of details associated with one or more registered sellers of the one or more products, and selected from a group consisting of name, location, contact number and, reviews.

In an embodiment, the one or more attributes of the one or more weeds comprise any or a combination of colour, edges, texture, shape, size, and venation pattern.

In an embodiment, the method comprises the steps of: identifying the one or more weeds at different growth stages of the corresponding weeds, and generating the one or more details associated with one or more recommended products for the identified one or more weeds, based on the growth stage of the corresponding identified weed.

In an embodiment, the method comprises the steps of: determining position of the identified one or more weeds in the captured one or more images, and correspondingly generating a sliding window for each of the identified one or more weeds, wherein the sliding window is computed based on dimension and position of the identified weeds in the image frame; and superimposing the generated sliding windows on the captured images and correspondingly transmitting a third set of data packets to the one or more first mobile devices of the users.

In an embodiment, the method further comprises a step of performing a callback function with one or more parameters. In an embodiment, the method further comprises a step of changing the parameters in callback function, as the trend of training changes gradually with progress and the addition of new datasets, by accessing the current state of the training unit considering the loss, accuracy, rate of change of accuracy and the likes. The one or more parameters can be the weights of connections between neurons of the CNN, the number of hidden layers, width of hidden layers, and the likes, of the CNN,

According to another aspect, the present disclosure elaborates upon a system for identifying weeds in images, the system comprising: one or more first mobile devices associated with one or more registered users, and a computing unit in communication with the one or more first mobile devices, the computing unit comprising one or more processors coupled with a memory, wherein the computing unit is configured to receive one or more images and location of an area of interest (AOI) from one or more devices; identify one or more weeds in the received one or more images, and correspondingly train for upcoming weed identification; and wherein the computing unit extracts one or more details pertaining to the identified one or more weeds based on the determined location of the AOI and the associated weeds, and correspondingly transmit a first set of data packets to the one or more first mobile devices.

In an embodiment, the computing unit is configured to: receive, from the one or more first mobile device, the captured one or more images of the AOI, and the corresponding location of the AOI and the associated one or more weeds; detect and extract one or more attributes associated with one or more weeds from the received one or more images of the AOI, wherein the computing unit extracts the one or more attributes upon a positive detection of the one or more attributes in the received one or more images; perform dimensionality reduction on the extracted one or more attributes to select a first set of attributes amongst the extracted one or more attributes; generate and feed, to an activation function, a feature vector corresponding to the selected first set of attributes, to determine probability of the received one or more images to fall in one or more class associated with one or more known weeds; and identify one or more weeds based on the determined probability of the one or more class, wherein the identified one or more weeds is associated with the corresponding class amongst the one or more class that has a maximum determined probability.

In an embodiment, the computing unit is configured with a convolutional neural network unit comprising base layers to identify the edges, and top layers to extract the one or more attributes, and wherein the CNN unit enables the computing unit to perform dimensionality reduction on the extracted one or more attributes to select the first set of attributes amongst the extracted one or more attributes.

In an embodiment, the computing unit is configured to update a training and testing dataset associated with the CNN unit, with a third set of data packets comprising any or a combination of the captured one or more images, and the corresponding extracted attributes, location of the one or more first mobile devices and the AOI, one or more details, and the identified one or more weed, which facilitates training of the computing unit for the upcoming weed identification requests and processes.

In an embodiment, the computing unit is configured to: obtain the feature vector generated from a hidden layer of the CNN, wherein the feature vector is generated based on the third set of data packets processed by the CNN; determine distances between the obtained feature vector and a plurality of clusters of feature vectors generated based on a plurality of training data in a training set previously processed by the CNN, wherein the plurality of training data previously processed by the CNN pertains to the one or more known weeds; identify, as a cluster corresponding to the feature vector, a cluster among the clusters corresponding to a shortest distance among the distances; in response to an accuracy of recognition for the training data being less than or equal to a threshold, select training data corresponding to the identified cluster from the plurality of training data in a training set; and training the CNN based on the selected training data for the upcoming weed identification.

In an embodiment, the computing unit is in communication with one or more second mobile devices associated with the one or more registered sellers.

A feature vector is an n-dimensional vector that represents the target weed present in the images or the entire captured image, in form of numerical (measurable) values for readability and further processing by the computing unit or the CNN. The activation function defines how the weighted sum of the input (feature vector) of the CNN is transformed into an output from the nodes or neurons of the CNN. The feature vector, herein comprises the numerical values of the first set of attributes selected after the dimensionality reduction, which can be fed to the computing unit to generate the feature vector. Further, this feature vector can be used by the CNN to provide a corresponding output based on the topology or parameters of the CNN model i.e number and structure of hidden layers, corresponding neurons, and their weight assigned and weighted sum between connections in the (pre-trained) CNN. The computing unit can accordingly predict the probability of the corresponding output of the CNN to fall within one or more classes of known weeds. Accordingly, the computing unit or CNN can identify one or more weeds based on the determined probability of the one or more class, where the identified one or more weeds can be associated with the corresponding class amongst the one or more class that has a maximum determined probability. For instance, if the probability of the target weed (in the captured image) falling into class-I weed is 30%, and the probability of the weed falling into class-II weed is 80%, the computing unit can recognize the weed to be in the class-II weed category and determines the target weed as the weed corresponding to the class-II weed.

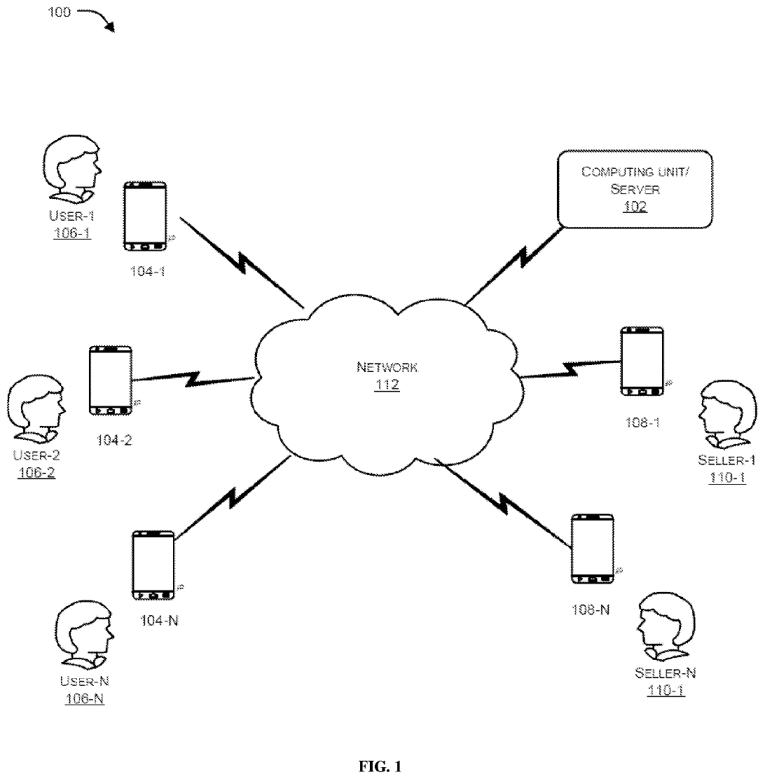

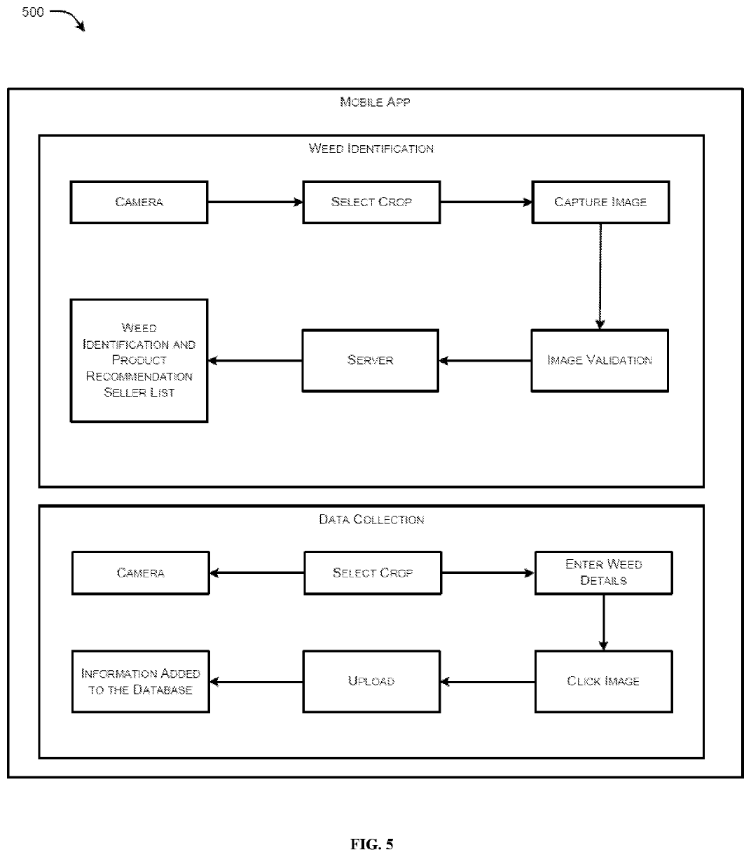

Referring to FIGS. 1 and 6, according to an aspect, the system 100 (also referred to as weed identification system 100, herein) can facilitate one or more users 106-1 to 106-N (collectively referred to as farmers 106 or users 106 or first users 106, herein) to connect to a computing unit 102 (also referred to as server 102, herein) associated with the system 100 through a network 112, using one or more first mobile devices 104-1 to 104-N (collectively referred to as first mobile device 104, herein). The system 100 can further allow one or more sellers 110-1 to 110-N (collectively referred to as sellers 110 or second users 110, herein) to connect to the network 112 and the computing unit 102, using one or more second mobile devices 108-1 to 108-N (collectively referred to second mobile devices 108, herein). The computing unit 102 in communication with the first mobile devices 104 and second mobile devices 108 associated with the users 106 and sellers 110 can enable processing and computation of images of an area of interest (AOI) having target crops and weeds, being captured by the users 106 through the first mobile devices 104, as well as the location of the AOI and the associated weeds, to identify weeds present in the captured images at any growth stage of the corresponding weed. Further, the computing unit 102 accordingly provides the users 106 with the details about recommended products that can be used on the identified weeds, as well as corresponding details of sellers 110 selling these recommended products, based on the geo-location of the weeds. System 100 can also allow authentication of users 106 and sellers 110 at the time of registering into the system 100 as well as every time the users 106 or sellers 110 connect or log into the system 100 so that only authenticated users 106 and sellers 110 can access the system 100.

According to another aspect, the weed identification method (also referred to as method, herein) can include a step of facilitating the users 106 to connect to the computing unit through the network 112, using the first mobile devices 104. The method can further include a step of allowing sellers 110 to connect to the network 112 and the computing unit 102, using the second mobile devices 108. The method can include a step of processing and computation of images of the AOI being captured by the users 106 through the first mobile devices 104, as well as the location of the AOI having associated weeds, to identify weeds present in the captured images. Further, the computing unit 102 can accordingly provide the users 106 with the details about products that can be used against the identified weeds, as well as corresponding details of sellers 110 selling these recommended products, based on the geo-location of the weeds. The method can also allow authentication of users 106 and sellers 110 at the time of registering into the system 100 as well as every time the users 106 or sellers 110 connect or log into the system 100 so that only authenticated users 106 and sellers 110 can access the system 100.

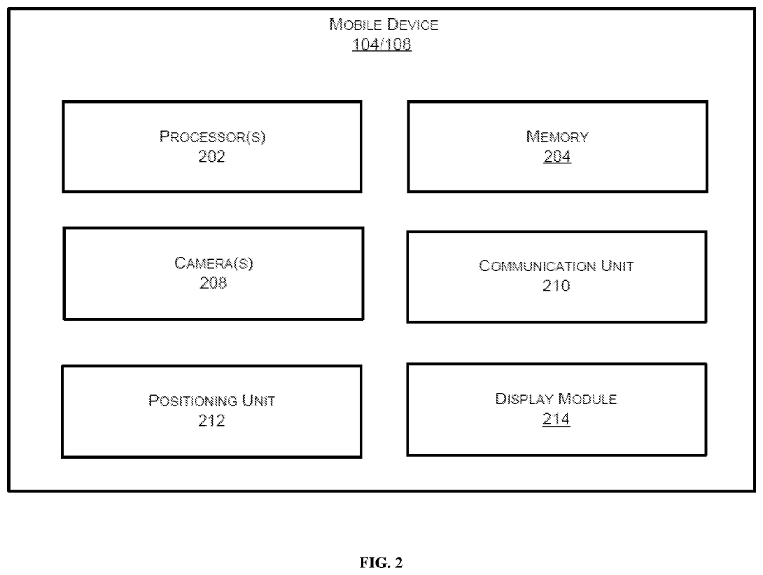

Referring to FIG. 2, each of the mobile devices 104, 108 can include an image acquisition unit comprising a camera 208 to capture one or more images associated with the AOI having desired target crops as well as the weeds. The mobile devices 104 can allow the users 106 to capture images of the AOI having the weeds, with or without the target crops that are intentionally grown, and transmit them to the computing unit 102, through the network 112. The mobile devices 104, 108 can further include a positioning unit 212 to monitor the geo-location of the AOI and the weeds based on the location of the mobile device 104 of the users 106 at the time of capturing the images, as well as the real-time and registered locations of the users 106 and sellers 110. The mobile devices 104, 108 can then accordingly transmit the geo-location of the weeds, and the real-time locations of the users 106 and sellers 110, to the computing unit, through the network. The mobile devices 104, 108 can also facilitate authentication of users 106 and sellers 110 at the time of registering as well as every time the user 106 or sellers 110 connects with the system 100, using any or a combination of OTP based system, password-based system, and biometric authentication systems, and the likes.

In an exemplary embodiment, the mobile devices 104, 108 can be any or a combination of smartphone, laptop, computer, and hand-held computing devices, but not limited to the likes. In an embodiment, the mobile devices 104, 108 can include a communication unit 210 selected from any or a combination of GSM module, WIFI Module, LTE/VoLTE chipset, and the likes to communicatively couple the mobile devices 104, 108 associated with the users 106 and sellers 110 with the computing unit 102 of the system 100. The mobile devices 104, 108 can also include a display unit 214 and input means to provide an interface for facilitating users to select already stored images of the weeds for identification and facilitate users 106 and sellers 110 to view and input necessary and required details of the users 106 and/or sellers 110 from/into the system 100. The mobile devices 104, 108 can include a positioning unit 212 such as but not limited to a global positioning system (GPS) module.

In an embodiment, the system 100 and the method can be implemented using any or a combination of hardware components and software components such as a cloud, a server, a computing system, a computing device, a network device, and the like (collectively designated as server 104, herein). Further, system 100 and the computing unit 102 for the method can interact with the users 106 and the sellers 110 through a mobile application that can reside in the mobile devices 104, 108 of the users 106 and the sellers 110. In an implementation, the system 100 can be accessed by an application that can be configured with any operating system, including but not limited to, Android™, iOS™, and the like.

Further, network 112 can be a wireless network, a wired network or a combination thereof that can be implemented as one of the different types of networks, such as Intranet, Local Area Network (LAN), Wide Area Network (WAN), Internet, and the like. Further, network 112 can either be a dedicated network or a shared network. The shared network 106 can represent an association of the different types of networks that can use a variety of protocols, for example, Hypertext Transfer Protocol (HTTP), Transmission Control Protocol/Internet Protocol (TCP/IP), Wireless Application Protocol (WAP), and the like.

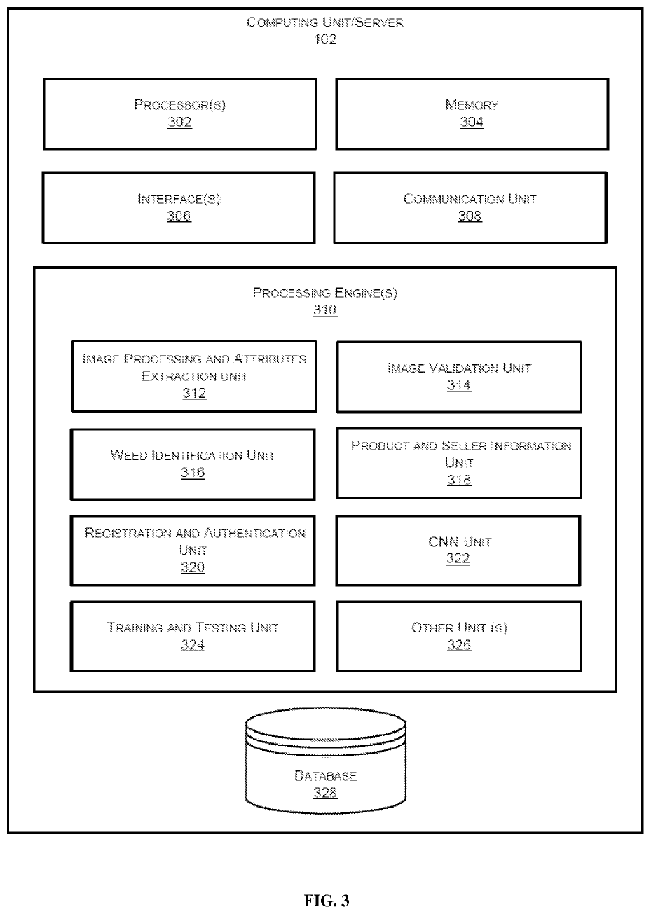

FIG. 3 illustrates an exemplary architecture of the computing unit 102 or server 102 of the system 100 and method for processing the images captured by the first mobile devices 104 and accordingly identify weeds and recommend corresponding products and nearby sellers based on the geo-location of the weeds.

As illustrated, the computing unit 102 of the system 100 and method can include one or more processor(s) 302. The one or more processor(s) 302 can be implemented as one or more microprocessors, microcomputers, microcontrollers, digital signal processors, central processing units, logic circuitries, and/or any devices that manipulate data based on operational instructions. Among other capabilities, the one or more processor(s) 302 are configured to fetch and execute computer-readable instructions stored in a memory 304 of the computing unit 102. The memory 304 can store one or more computer-readable instructions or routines, which may be fetched and executed to create or share the data units over a network service. The memory 304 can include any non-transitory storage device including, for example, volatile memory such as RAM, or non-volatile memory such as EPROM, flash memory, and the like.

In an embodiment, the computing unit 102 can also include an interface(s) 306. The interface(s) 306 can include a variety of interfaces, for example, interfaces for data input and output devices referred to as I/O devices, storage devices, and the like. The interface(s) 306 can facilitate communication of computing unit 102 with various devices coupled to computing unit 102. The interface(s) 306 can also provide a communication pathway for one or more components of the computing unit 102. Examples of such components include, but are not limited to, processing engine(s) 310 and database 328.

In an embodiment, the computing unit 102 can include a communication unit 308 operatively coupled to one or more processor(s) 302. The communication unit 308 can be configured to communicatively couple the computing unit 102 to the mobile devices 104, 108 of the users 106, and the sellers 110. In an exemplary embodiment, the communication unit 308 can include any or a combination of Bluetooth module, NFS Module, WIFI module, transceiver, and wired media, but not limited to the likes.

In an embodiment, the processing engine(s) 310 can be implemented as a combination of hardware and programming (for example, programmable instructions) to implement one or more functionalities of the processing engine(s) 310. In the examples described herein, such combinations of hardware and programming may be implemented in several different ways. For example, the programming for the processing engine(s) 310 can be processor-executable instructions stored on a non-transitory machine-readable storage medium, and the hardware for the processing engine(s) 310 can include a processing resource (for example, one or more processors), to execute such instructions. In the present examples, the machine-readable storage medium may store instructions that, when executed by the processing resource, implement the processing engine(s) 310. In such examples, the computing unit 102 can include the machine-readable storage medium storing the instructions and the processing resource to execute the instructions, or the machine-readable storage medium may be separate but accessible to the computing unit and the processing resource. In other examples, the processing engine(s) 310 can be implemented by electronic circuitry. Database 328 can include data that is either stored or generated as a result of functionalities implemented by any of the components of the processing engine(s) 310.

In an embodiment, the processing engine(s) 310 can include an image processing and attributes extraction unit 312, an image validation unit 314, a weed identification unit 316, a product and seller information unit 318, a registration and authentication unit 320, a convolutional neural network (CNN) unit 322, a training and testing unit 324, and other unit (s) 326. but not limited to the likes. The other unit(s) 326 can implement functionalities that supplement applications or functions performed by computing unit 102 or the processing engine(s) 310.

In an exemplary embodiment, the communication unit 308 can enable computing unit 102 to receive the captured images of the AOI, and the corresponding location of the weeds and the users 106 from the first mobile devices 104. Further, the communication unit 308 can also enable the computing unit 102 to receive details and the location of sellers 110 from the second mobile devices. 110. In an exemplary embodiment, the image processing and attributes extraction unit 312 can enable the computing unit 102 to detect and extract one or more attributes associated with one or more weeds from the received one or more images of the AOI, for further processing and identification of weeds. In an exemplary embodiment, the one or more attributes can be any or a combination of color, edges, texture, shape, size, and venation pattern, but not limited to the likes.

In an exemplary embodiment, the image validation unit 314 can enable the computing unit to allow the image processing and attributes extraction unit 312 to further extract the one or more attributes from the received images only if one or more attributes are associated with the weeds are detected in the received images. Upon a negative detection of the one or more attributes in the received images, the image validation unit 314 can enable the computing unit to transmit a set of data packets, to the first mobile devices 104, pertaining to an alert message for initiating recapturing of one or more images of the AOI, and displaying alert for an invalid image to the users. Thus, the present invention (system 100 and method) are capable of filtering and restricting entry of invalid or unwanted images or data into system 100 or computing unit 102, which are not related to weeds, thereby preventing various security threats.

In another embodiment, the first mobile devices 104 can be configured to detect the one or more attributes present in the captured images, and only upon a positive detection, the first mobile devices 104 can send the captured one or more images to the computing unit 102, thereby restricting entry of invalid or unwanted images or data into the system 100 or computing unit 102, which are not related to weeds.

In another embodiment, the first mobile devices 104 can be configured to encode the captured images before uploading the captured images to the server 102 so that the information remains secure and any other malicious file is not uploaded along with that, thereby preventing various security threats.

In an exemplary embodiment, the weed identification unit 316 can be configured with the convolutional neural network (CNN) unit 322 of the system 100 and can enable the computing unit 102, upon positive detection by the image validation unit 314, to process and compute the validated images and the extracted attributes to identify the one or more weeds. The CNN unit 322 can include a plurality of layers, wherein base layers of the CNN 322 can be configured to identify the edges in the images, and top layers can be configured to extract the one or more attributes and enable the computing unit 102 to perform dimensionality reduction on the extracted one or more attributes to select a first set of attributes amongst the extracted one or more attributes, thereby reducing non-relevant attributes and select only the relevant attributes. Further, the weed identification unit 316 and the CNN 322 can enable the computing unit 102 to generate and feed, to an activation function, a feature vector corresponding to the selected first set of attributes, to determine the probability of the received one or more images to fall in one or more class associated with one or more known weeds. The weed identification unit 316 and the CNN 322 can then identify one or more weeds at any growth stage of the corresponding weed by determining the corresponding class that is having a maximum determined probability. This can help provide more fine-tuned recommendations of products to user 106.

The CNN unit 322 is capable of reducing the ratio of dimensionality on the extracted one or more attributes during the weed identification process. In an embodiment, the CNN unit 322 is configured to perform dimensionality reduction on the extracted one or more attributes of the captured images. In an exemplary implementation, the dimensionality of the extracted one or more attributes of the captured images is reduced to a dimensionality ranging from 200×200×3 to 900×900×3. In a preferred embodiment, the dimensionality of the extracted one or more attributes of the captured images is further reduced to a dimensionality ranging from 1×1×1700 to 10×10×250. The output of the CNN unit may be further reduced across multiple layers. This step of dimensionality reduction improves the computation speed and reduces the computational load on the computing unit 102 while identifying weeds in the captured images.

Upon identification of the one or more weeds, the computing unit 102 and the CNN unit 322 are capable of extracting one or more details pertaining to the identified weeds based on the received location of the AOI and associated weeds, and the first mobile devices 104, and correspondingly transmitting the first set of data packets to the first mobile devices 104 associated with the users 106.

In some instances, many weeds can exist in one image frame or the AOI. In such a case, the weed identification unit 316 can enable the computing unit 102 to provide a list of the probable weeds to user 106, based on the extent of possibility or a confidence score of the corresponding weeds.

In an embodiment, the one or more details pertaining to the identified weeds can include a first set of details selected from but not limited to a common name, family name, class, and regional name. In another embodiment, the one or more details can include a second set of details associated with one or more recommended products selected from but not limited to type, name, price, usage instructions, dosage, application, and precautionary measures. In yet another embodiment, one or more details can include a third set of details associated with registered sellers 110 of the one or more products selected from but not limited to name, location, contact number, email address, and product reviews and seller reviews.

In an exemplary embodiment, the product and seller information unit 318 can enable the computing unit 102 to request the sellers 110 about the third set of details associated with the sellers, at the time when the sellers 110 registers with the system 100. At the time of registering into the system 100 as well as at the time of logging into the system, the computing unit 102 can determine the location and distance of the registered sellers 110 selling the corresponding products. As a result, the computing unit 102 in communication with the mobile devices 104, 108 of the sellers 110 and the users 106 can determine the required product and corresponding weed and product details for the identified weeds, and also determine the location and distance of the nearby registered sellers 110 selling the corresponding products, based on the monitored geo-location of the weeds. This restricts unauthenticated as well as authenticated users 106 and sellers 110 to provide intentional or unintentional false details about their current geo-location.

Database 328 can store a product catalog having the one or more details associated with the weeds, sellers, and products. The product and seller information unit 318, upon identification of weed, can enable the computing unit 102 to provide the product catalog, on the first mobile device 104 of users 106. This can help users 106 browse through all the products and their details. Further, the products can be filtered based on multiple filters like weeds, crops, pricing, and the like.

In an exemplary embodiment, the registration and authentication unit 320 can enable the computing unit 102 to authenticate and register the users 110 and sellers 106, and their corresponding first mobile devices 104 and second mobile devices 108, with the system 100. Upon receiving a request for registration from any or a combination of the sellers 106 and the users 110 in the system 100, the registration and authentication unit 320 can enable the computing unit 102 to send, to any or a combination of the first mobile devices 104, and the second mobile devices 108, a unique authentication password or a one-time password (OTP) on a registered mobile number, which upon inputting into the corresponding mobile devices 104, 108 of the users 106 or sellers 110, registers the corresponding sellers 110 and the users 106 into the system 100. Further, the computing unit 102 can transmit, to any or a combination of the corresponding first mobile devices 104, and the second mobile devices 108, upon a positive registration, a set of third data packets pertaining to a request for any or a combination of one or more seller details, and one or more seller details.

The system 100 can further authenticate the registered users 106, and the registered sellers 110, upon verification of the corresponding user details, and seller details received from their mobile devices 104, 108. A registered person at the computing unit end can physically verify the provided seller and user details. The registered person can log into the computing unit 102 or sever 102 via a registered Email ID or other login credentials, and upon login, the registered person can access and authenticate the uploaded user details, and seller details.

In another embodiment, the computing unit 102 can be configured to transmit a unique authentication password or OTP on a registered mobile number of any or a combination of the first mobile devices 104, and the second mobile devices 108 of the registered users 106 and sellers 110, every time the sellers or users try to login into their corresponding mobile devices 104, 108. Further, only upon inputting the same received unique authentication password or OTP into the corresponding mobile devices 104, 108, the corresponding sellers and the users are allowed to access the system 100.

In an exemplary embodiment, the training and testing unit 324 can enable the computing unit 102 and the CNN 322 to update a training and testing dataset associated with the convolutional neural network unit 322, with a third set of data packets comprising any or a combination of the captured images (by the first mobile device), and the corresponding extracted attributes, location of the weeds at the time of capturing the images by the mobile device 104, and the identified weeds, so that the system 100 updates and trains it to further improve weed identification process, making it accurate and reliable for next weed identification processes. In an embodiment, the computing unit 102 is configured to obtain the feature vector generated from a hidden layer of the CNN 322, based on the third set of data packets. The computing unit 322 can then determine distances between the obtained feature vector, and a plurality of clusters of feature vectors generated based on a plurality of training data in a training set previously processed (based on attributes of the one or more known weeds) by the CNN. Further, the computing unit 102 can correspondingly identify a cluster corresponding to the feature vector, among the plurality of clusters of previously processed data based on a shortest distance among the determined distances. Furthermore, the CNN 322 can be tested based on the training data of the identified cluster to determine the reliability of the weed recognition. Accordingly, in response to an accuracy of recognition for the training data being less than or equal to a threshold, the computing unit 102 can select training data corresponding to the identified cluster from the plurality of training data in a training set for training the CNN for the upcoming weed identification. The CNN 322 can then determine the weights or parameters for the CNN 322 to fit with the given training data, and update the CNN model for the upcoming weed identification.

The training and testing unit 324 can be configured with an optimizer that optimizes the training and testing unit 324 based on the current state of the training model and other changing parameters. Further, a balance function module associated with the computing unit 103 can analyze the imbalance in the dataset and help gradient descent by allowing loss to reach closest to the global minimum. It prevents the CNN model to overtrain and undertrain certain categories with the high and less count in the data sample respectively by applying correction on the weight difference with respect to the category.

In an embodiment, the computing unit 102 can determine the position of the identified weeds in the captured images, and can correspondingly generate a sliding object detection window for each of the identified weeds. The computing unit 102 can compute the sliding window based on the dimension and position of the identified weeds in the image frame. Further, the computing unit 102 can superimpose the generated sliding windows on the captured images, which can improve the accuracy levels of weed identification by not just classifying the image to a particular weed name but also locating the position of weed in that input image, so that the user 106 can easily identify the weed and its position in the image or AOI. This can help in identifying more correct features of weed and AOI in the image by separating the other environmental or noisy details.

In an embodiment, database 328 can store multiple reference images corresponding to each weed. The computing unit 102, upon detection of any weed in the image frame, can provide and display the reference images of the identified weed name along with the inference to the user 106. This can allow user 106 to validate the weed detection. For instance, in case user 106 is unsure about weed detection, user 106 can choose to view more possibilities. The computing unit 102 can then list the alternatives in order of possibility. Further, if user 106 finds a better weed image matching with the actual captured image by him/her, the image can be selected to get the recommendation accordingly. This allows validation of recommendations using similar images and provides alternative solutions based on user satisfaction.

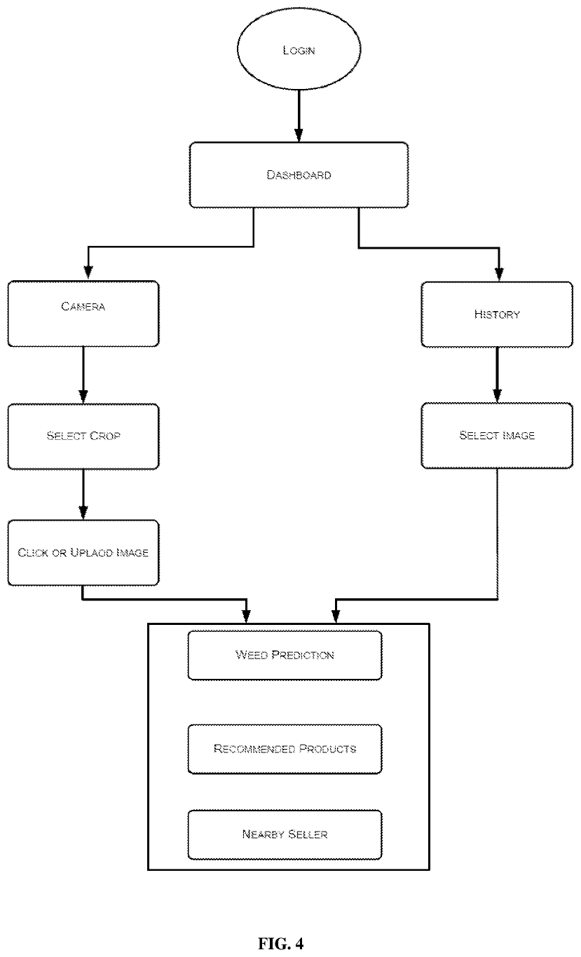

Referring to FIGS. 4 and 5, in an implementation, the system 100 and the method can allow users to capture one or more images of AOI having weeds to be identified using the mobile devices 104, 108. Later, the display and input mean on the first mobile device 104 can also allow the registered users 106 to select a crop and upload at least one of the captured one or more images on the computing unit 102 or the system 100. Further, computing unit 102 can validate the uploaded images and store the valid images in database 328 after positive detection of attributes pertaining to weeds in the images. In another implementation, the computing unit 102 can later enable the registered users to access and select, using the first mobile devices 104, at least one of the stored valid images for a second identification of the one or more weeds as well as getting the corresponding one or more details. The computing unit 102 can identify or predict the weeds in the selected images, recommend products and provide details of the recommended product that can be used against the identified weeds, and finally, provide details and location of nearby registered sellers 110 to the registered users 106.

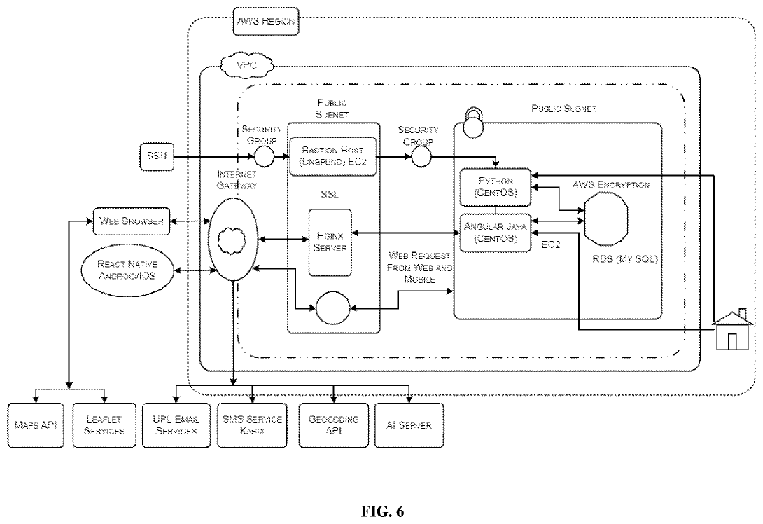

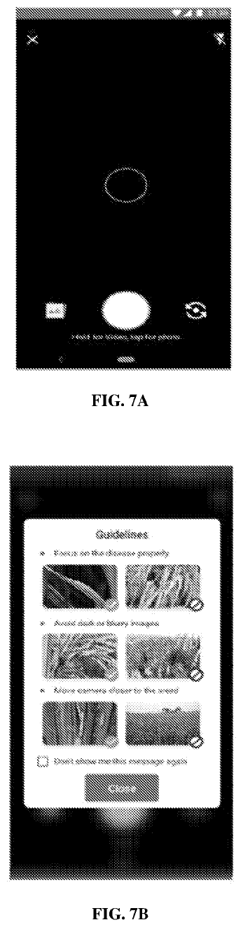

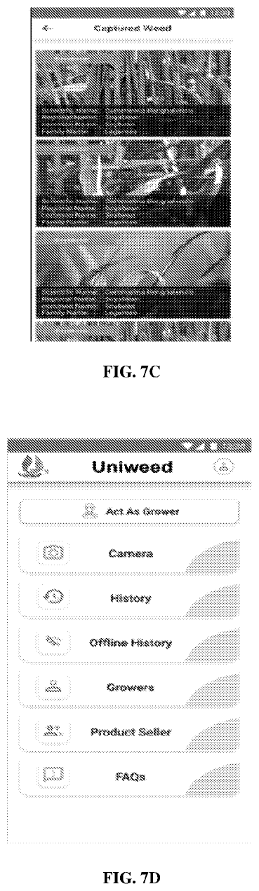

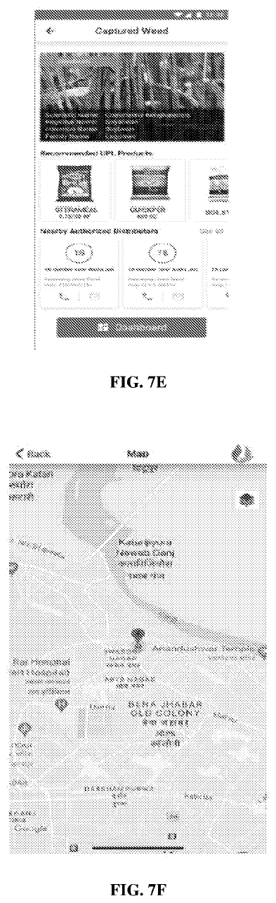

Referring to FIGS. 7A to 7F, exemplary views of a display module 214 of the first mobile device 104 associated with user 106 are disclosed. User 106 can capture an image of the AOI having the target crop using the camera of their mobile device 104 as shown in FIG. 7A. The system can then provide a set of instructions/guidelines, on the display module 104 of the mobile device 104 of user 106 for better image capturing as shown in FIG. 7B. As shown in FIG. 7C. the display module 214 is showing the identified weed having a scientific name: Commelina Benghalensis, a common name: Soybean, Family: Legume, and Regional Name: Soyabean. Further, as shown in FIG. 7D, the display unit 104 can also provide other features such as history, offline history, list growers and product seller option, and FAQs. The display unit 104 can then show corresponding products to be used against the identified weed, and details of the nearby sellers based on the geolocation of the weeds as shown in FIG. 7E. Further, the display unit 104 can also show the location of the sellers over a map as shown in FIG. 7F.

Thus, the present invention can provide an easy to use, efficient, accurate, and reliable system, platform, and method for identifying weeds at different growth stages in images being captured using mobile devices in all environmental conditions, which provides authenticated users with details about products that can be used against the identified weeds, and corresponding details of available authenticated sellers based on the geo-location of the weeds.

In another embodiment, the present invention (system 100 and method) can also be configured to operate in an offline mode, without an internet connection. In the offline mode, the invention can be capable of identifying weeds in images and provide the authenticated users with details about products that can be used against the identified weeds, and corresponding details of available authenticated sellers 110 based on the geo-location of the weeds. In an embodiment, the authenticated users can capture one or more images of one or more weeds even in the offline mode. The captured one or more images will be uploaded to the server whenever the internet connection is made available.

As used herein, and unless the context dictates otherwise, the term “coupled to” is intended to include both direct coupling (in which two elements are coupled to each other or in contact with each other) and indirect coupling (in which at least one additional element is located between the two elements). Therefore, the terms “coupled to” and “coupled with” are used synonymously.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT INVENTION

The present invention overcomes the drawbacks, shortcomings, and limitations associated with existing weed recognition systems and methods.

The present invention identifies weeds in images being captured using mobile devices, irrespective of environmental conditions.

The present invention identifies weeds at different growth stages of the weed.

The present invention provides a stage-wise weed identification for detecting weeds at their different growth stages and also recommends the required product for the weed based on the growth stage, type, and geo-location of the weed.

The present invention improves the accuracy level of the weed identification process by not just classifying the image to a particular weed name but also locating the position of weed in that input image.

The present invention provides a system and method for identifying weeds using mobile devices, which provides users with various reference images of the identified weeds in order of possibility to validate the recommendations and provide alternate solutions on customer satisfaction.

The present invention provides a product catalog feature to users, which can be added to help users to browse through all the products and their details.

The present invention provides a system and method for identifying weeds using mobile devices, which alerts users to recapture the images of the weed of identification in case the users fail to correctly capture the image of the weeds.

The present invention provides a system and method for identifying weeds, which filters and restricts entry of invalid or unwanted images or data into the system, which are not related to weeds, thereby preventing any security threats.

The present invention provides a system and method for identifying weeds using mobile devices, which provides authenticated users with details about products that can be used against the identified weeds at different growth stages, and corresponding details of available authenticated sellers based on the current geo-location of the weeds

The present invention trains the weed identification system with previous as well as present datasets to improve the weed identification capability of the system for upcoming weed identification requests and processes.

The present invention improves the computation speed and reduces the computational load on the system while identifying weeds in the captured images.

The present invention provides an easy to use, efficient, accurate, and reliable system and method for identifying weeds in images being captured using mobile devices, which provides authenticated users with details about products that can be used against the identified weeds, as well as corresponding details of available authenticated sellers based on current geo-location of the weeds.

1. A method for identification of weeds in images, the method comprising:
receiving one or more images of an area of interest (AOI) being captured by one or more mobile devices (104) associated with one or more registered users (106), and a corresponding location of the AOI;
identifying one or more weeds in the received one or more images, and training a computing unit (102) with the identified one or more weeds;
extracting one or more details pertaining to the identified one or more weeds based on the determined location of the AOI and the associated weeds, and
transmitting a first set of data packets to the one or more first mobile devices (104).

2. The method as claimed in claim 1 further comprising
detecting and extracting one or more attributes associated with one or more weeds from the received one or more images of the AOI, wherein extracting the one or more attributes is performed upon a positive detection of the one or more attributes in the received one or more images;
performing dimensionality reduction on the extracted one or more attributes to select a first set of attributes amongst the extracted one or more attributes;
generating and feeding, to an activation function, a feature vector corresponding to the selected first set of attributes, to determine probability of the received one or more images to fall in one or more class associated with one or more known weeds; and
identifying one or more weeds in the one or more images based on the determined probability of the one or more class, wherein the identified one or more weeds is associated with corresponding class amongst the one or more class that has a maximum determined probability.

3. The method as claimed in claim 2, wherein performing the dimensionality reduction on the extracted one or more attributes of the captured images provides a dimensionality ranging from 200×200×3 to 900×900×3.

4. The method of claim 2, wherein performing the dimensionality reduction on the extracted one or more attributes of the captured images provides a dimensionality ranging from 1×1×1700 to 10×10×250.

5. The method of claim 1, wherein upon a negative detection of the one or more attributes in the received one or more images, the method further comprises transmitting, to the one or more first mobile devices (104), a second set of data packets pertaining to an alert message for initiating recapturing of one or more images of the AOI.

6. The method of claim 1, further comprising enabling the one or more registered users (106) to access and select, using the one or more first mobile devices (104), at least one of the images for identification of the one or more weeds from the selected images and corresponding one or more details.

7. The method as claimed in claim 6, wherein the one or more details pertaining to the identified one or more weeds comprises:
a first set of details associated with the identified one or more weeds, and selected from a group consisting of common name, family name, class, and regional name;
a second set of details associated with one or more recommended products for the identified one or more weeds, and selected from a group consisting of type, name, price, usage instructions, dosage, application, and precautionary measures; and
a third set of details associated with one or more registered sellers (110) of the one or more products, and selected from a group consisting of name, location, contact number, and reviews.

8. The method as claimed in claim 2, wherein the one or more attributes of the one or more weeds comprises any or a combination of colour, edges, texture, shape, size, and venation pattern.

9. The method as claimed in claim 1 further comprising:
identifying the one or more weeds at different growth stages of the corresponding weeds, and
generating the one or more details associated with one or more recommended products for the identified one or more weeds, based on the growth stage of the corresponding identified weed.

10. The method as claimed in claim 1 further comprising:
determining a position of the identified one or more weeds in the captured one or more images, and correspondingly generating a sliding window for each of the identified one or more weeds, wherein the sliding window is computed based on a dimension and the position of the identified weeds in the image frame; and
superimposing the generated sliding windows on the captured images and correspondingly transmitting a third set of data packets to the one or more first mobile devices (104) of the users (106).

11. A system (100) for identifying weeds in images, the system (100) comprising:
one or more first mobile devices (104) associated with one or more registered users (106);
a computing unit (102) in communication with the one or more first mobile devices (104), the computing unit (102) comprising one or more processors (302) coupled with a memory (304), wherein the computing unit (102) is configured to receive one or more images and location of an area of interest (AOI) from one or more devices (104); and
identify one or more weeds in the received one or more images, and correspondingly train for upcoming weed identification,
wherein the computing unit (102) extracts one or more details pertaining to the identified one or more weeds based on the determined location of the AOI and the associated weeds, and correspondingly transmits a first set of data packets to the one or more first mobile devices (104).

12. The system (100) as claimed in claim 11, wherein the computing unit (102) is configured to:
receive, from the one or more first mobile devices (104), the captured one or more images of the AOI, and the corresponding location of the AOI and the associated one or more weeds;
detect and extract one or more attributes associated with one or more weeds from the received one or more images of the AOI, wherein the computing unit (102) extracts the one or more attributes upon a positive detection of the one or more attributes in the received one or more images;
perform dimensionality reduction on the extracted one or more attributes to select a first set of attributes amongst the extracted one or more attributes;
generate and feed, to an activation function, a feature vector corresponding to the selected first set of attributes, to determine probability of the received one or more images to fall in one or more classes associated with one or more known weeds; and
identify one or more weeds based on the determined probability of the one or more class, wherein the identified one or more weeds is associated with the corresponding class amongst the one or more class that has a maximum determined probability.

13. The system (100) of claim 12, wherein the computing unit (102) is configured with a convolutional neural network unit (322) comprising base layers to identify the edges, and top layers to extract the one or more attributes, and wherein the CNN unit (322) enables the computing unit (102) to perform dimensionality reduction on the extracted one or more attributes to select the first set of attributes amongst the extracted one or more attributes.

14. The system (100) of claim 12, wherein the computing unit (102) is configured to update a training and testing dataset associated with the CNN unit (322), with a third set of data packets comprising any or a combination of the captured one or more images, and the corresponding extracted attributes, location of the one or more first mobile devices (104) and the AOI, one or more details, and the identified one or more weed, which facilitates training of the computing unit (102) for the upcoming weed identification.

15. The system (100) of claim 12, wherein the computing unit (102) is configured to:
obtain the feature vector generated from a hidden layer of the CNN (322), wherein the feature vector is generated based on the third set of data packets processed by the CNN (322);
determine distances between the obtained feature vector and a plurality of clusters of feature vectors generated based on a plurality of training data in a training set previously processed by the CNN (322), wherein the plurality of training data previously processed by the CNN (322) pertains to the one or more known weeds;
identify, as a cluster corresponding to the feature vector, a cluster among the clusters corresponding to a shortest distance among the distances;
in response to an accuracy of recognition for the training data being less than or equal to a threshold, select training data corresponding to the identified cluster from the plurality of training data in a training set; and training the CNN (322) based on the selected training data for the upcoming weed identification.

16. The system (100) of claim 11, wherein the computing unit (102) is in communication with one or more second mobile devices (108) associated with the one or more registered sellers (110).
